(19) United States
(12) Patent Application Publication
(10) Pub. No.: US 2026/0066434 A1
(43) Pub. Date: Mar. 5, 2026

(54) SYSTEM AND METHOD FOR REMOTE BATTERY DOOR BUTTON WITH TWO-PHASE ACTIVATION

(71) Applicant: DISH Network L.L.C., Englewood, CO (US)

(72) Inventors: Steven Nedved, Littleton, CO (US); Amber Bellerjeau, Littleton, CO (US)

(21) Appl. No.: 18/820,072

(22) Filed: Aug. 29, 2024

(51) Int. Cl. H01M 50/262; H01M 50/247; H01M 50/271

(52) U.S. Cl. CPC H01M 50/262; H01M 50/247; H01M 50/271; H01M 2220/30

(57) ABSTRACT

A system for a remote battery door button is disclosed. The system includes: a holder bracket, a compression member, an outer lock button, and an inner lock button. The outer lock button has a lower surface that rests upon the compression member. The outer lock button being depressible by compressing the compression member against the holder bracket. The outer lock button includes a hook latch that selectively secures to a fixed latch to secure a remote battery door to a remote body. The inner lock button is seated within the outer lock button, and is rotatable within the outer lock button. A lower surface of the inner lock button includes protrusions that protrude into the openings of the holder bracket when the inner lock button is depressed in the unlocked position, and unlatches the hook latch of the outer lock button from the fixed latch.

### BACKGROUND

Remote control devices for televisions, as well as other electronic devices are widely used. Most of these remote control devices are powered by batteries, which need to be replaced from time to time. Accordingly, such remote control devices often have a battery compartment inside of the remote control device and a battery door that covers the battery compartment.

Typically, these battery doors that cover the battery compartment do not have any kind of locking mechanism. One reason for this lack of locking mechanisms is that if the key to the locking mechanism were to be lost, the remote control device would then be worthless once the battery had died. Additionally, there is a desire not to require specialty tools for opening the locking mechanism that may be difficult to locate when needed.

Nevertheless, there are many situations where having a locking mechanism for the battery compartment may be appropriate. For example, when small children are present, there may be a desire to prevent the small children from removing the battery door and batteries from the remote control device, which then could become a choking hazard. Additionally, there may be other situations with users of various ages, physical conditions, or mental capacities where having a locking mechanism for the battery compartment may be appropriate. Thus, there is a technological challenge to address of how to incorporate an appropriate locking mechanism for the battery compartment, but still make the locking mechanism not overly difficult to open so that there is unacceptable user frustration. The present disclosure addresses this and other needs.

### BRIEF SUMMARY

The present disclosure relates generally to a system and method for a remote battery door button, and more particularly, but not exclusively, to a system and method for a remote battery door button with two-phase unlocking activation. There is a continuing need for a system and method that provide the proper balance of security of the battery door with the user convenience of replacing the batteries when need.

The present disclosure is directed towards a system for a remote battery door button. In at least one implementation, the system includes: a remote body, a remote battery door, a holder bracket, a compression member, an outer lock button, and an inner lock button. The remote body includes a fixed latch for securing the remote battery door. The remote battery door has guiderails on each longitudinal side of the remote battery door. Additionally, the remote battery door has a locked position and an unlocked position. The holder bracket includes one or more slots, and is operatively connected to the remote battery door. The compression member is mounted on the holder bracket, and is sandwiched between the outer lock button and the holder bracket, such that if the outer lock button is depressed towards that holder bracket, the compression member is initially compressed, but provides resistance that pushes the outer lock button back into its original position after the depress force is removed.

The outer lock button is operatively associated with the remote battery door. The lower surface of the outer lock button rests upon the compression member. The outer lock button is depressible by compressing the compression member against the holder bracket. Additionally, the outer lock button includes an inner circumference wall having a groove therein. Further, the outer lock button includes a hook latch that selectively secures to the fixed latch of the remote body to secure the remote battery door to the remote body. The inner lock button is seated within the outer lock button. Additionally, the inner lock button includes one or more tongues on at least a portion of an outer circumference wall of the inner lock button. The one or more tongues of the inner lock button are rotatable within the groove of the outer lock button. Further, a lower surface of the inner lock button includes one or more ribs that protrude into the one or more slots of the holder bracket when the inner lock button is depressed in the unlocked position but not when the inner lock button is depressed in the locked position. Finally, depressing the inner lock button when it is in the unlocked position also enables depression of the outer lock button, and unlatches the hook latch of the outer lock button from the fixed latch of the remote body.

In some embodiments of the system for a remote battery door button, the remote battery door includes guiderails on each longitudinal side of the remote battery door. In another aspect of some embodiments, the guiderails on each longitudinal side of the remote battery door include primary guiderails and secondary guiderails on each longitudinal side of the remote battery door. In still another aspect of some embodiments, the remote body includes a battery door opening and a longitudinal sidewall on each longitudinal side of the battery door opening, and wherein each longitudinal sidewall includes guide tracks that are configured to receive the guiderails from the remote battery door. In yet another aspect of some embodiments, the system further includes a detent feature on the remote body that interacts with a corresponding guiderail on the remote battery door to stop the remote battery door at a designated travel stop position. Further, in another aspect of some embodiments, the compression member provides resistance force in response to the button being pushed. The compression member includes one or more of a compression pad, a spring, or biasing device.

In one or more embodiments of the system for a remote battery door button, the inner lock button has a locked position where the inner lock button and outer lock button cannot be depressed, and an unlocked position where the inner lock button and outer lock button can be depressed into the remote body. In another aspect of some embodiments, when the inner lock button is in the locked position, the inner lock button is out of phase, with the ribs of the inner lock button rotated 90 degrees from the slots of the holder bracket. In still another aspect of some embodiments, when the inner lock button is in an unlocked position, the inner lock button is in phase, with the ribs of the inner lock button in line with the slots of the holder bracket, and depressable into the slots of the holder bracket. In yet another aspect of some embodiments, the outer lock button is not rotatable. Further, in another aspect of some embodiments, an upper surface of the inner lock button includes a rotation slot for engaging with a tool to rotate the inner lock button between a locked position and an unlocked position.

In another embodiment, a system for a remote battery door button is also disclosed. The system includes: a holder bracket, a compression member, an outer lock button, and an inner lock button. The holder bracket includes one or more slots. The compression member is mounted on the holder bracket. The outer lock button has a lower surface that rests upon the compression member. The outer lock button being depressible by compressing the compression member against the holder bracket. The outer lock button includes a hook latch that selectively secures to a fixed latch to secure a remote battery door to a remote body. The inner lock button is seated within the outer lock button, and is rotatable within the outer lock button. A lower surface of the inner lock button includes protrusions that protrude into the openings of the holder bracket when the inner lock button is depressed in the unlocked position. Depressing the inner lock button when in the unlocked position also enables depression of the outer lock button and unlatches the hook latch of the outer lock button from the fixed latch.

In some embodiments, the system for a remote battery door button further includes: a remote body including the fixed latch; and a remote battery door having a locked position and an unlocked position, the remote battery door including guiderails on each longitudinal side of the door. In other embodiments, the system for a remote battery door button further includes: a remote body having a locked position and an unlocked position, the remote battery door including guiderails on each longitudinal side of the door; and a remote battery door including the fixed latch. In another aspect of some embodiments, the compression member provides resistance force in response to the button being pushed. The compression member includes one or more of a compression pad, a spring, or biasing device. In still another aspect of some embodiments, the inner lock button has a locked position where the inner lock button and outer lock button cannot be depressed, and an unlocked position where the inner lock button and outer lock button can be depressed into the remote body.

In one or more embodiments of the system for a remote battery door button, when the inner lock button is in the locked position, the inner lock button is out of phase, with the protrusions of the inner lock button rotated 90 degrees from the openings in the holder bracket. In another aspect of some embodiments, when the inner lock button is in an unlocked position, the inner lock button is in phase, with the protrusions of the inner lock button corresponding in position and orientation with the openings of the holder bracket, and depressable into the openings of the holder bracket. In still another aspect of some embodiments, the outer lock button is not rotatable. In yet another aspect of some embodiments, an upper surface of the inner lock button includes a rotation slot for engaging with a tool to rotate the inner lock button between a locked position and an unlocked position.

In still another embodiment, a method for a remote battery door button is disclosed. The method includes: providing a remote body that includes a fixed latch and two longitudinal side walls, the two longitudinal side walls include guide tracks; providing a remote battery door that is slidably engaged onto the remote body, the remote battery door including guiderails on each longitudinal side of the remote battery door, wherein the guiderails of the remote battery door correspondingly engage with the guide tracks of the remote body, wherein a holder bracket with a compression member mounted thereon is operatively connected to the remote battery door, the holder bracket including one or more slots; securing a hook latch of an outer lock button to the fixed latch of the remote body to secure the remote battery door to the remote body, wherein the outer lock button is operatively associated with the remote battery door, the outer lock button including an inner circumference wall having a groove therein, and wherein a lower surface of the outer lock button rests upon the compression member; rotating an inner lock button seated within the outer lock button from a locked position into an unlocked position, the inner lock button including one or more tongues on at least a portion of an outer circumference wall of the inner lock button, wherein the one or more tongues of inner lock button are rotatable within the groove of the outer lock button; depressing the inner lock button against the holder bracket via compression of the compression member with the inner lock button in the unlocked position, the inner lock button having a lower surface with one or more ribs that protrude into the one or more slots of the holder bracket when the inner lock button is depressed in the unlocked position; and unlatching the hook latch of the outer lock button from the fixed latch of the remote body, in response to the depression of the inner lock button and the outer lock button, thereby releasing the remote battery door from the remote body.

These features with other technological improvements, which will become subsequently apparent, reside in the details of construction and operation as more fully described hereafter and claimed, reference being had to the accompanying drawings forming a part hereof.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates a perspective view of a system and method for a remote battery door button, in accordance with a disclosed embodiment.

FIG. 2 illustrates a transverse cut-away perspective view of a system and method for a remote battery door button, in accordance with a disclosed embodiment.

FIG. 3A illustrates a longitudinal cut-away perspective view of a system and method for a remote battery door button in an unlocked position, before the inner and outer lock button are depressed.

FIG. 3B illustrates a longitudinal cut-away perspective view of a system and method for a remote battery door button in an unlocked position, after the inner and outer lock button are depressed.

FIG. 3C illustrates a longitudinal cut-away perspective view of a system and method for a remote battery door button in a locked position.

FIG. 4A illustrates a bottom perspective view of an inner lock button of the system and method for a remote battery door button, in accordance with a disclosed embodiment.

FIG. 4B illustrates a bottom perspective view of an outer lock button of the system and method for a remote battery door button, in accordance with a disclosed embodiment.

FIG. 5A illustrates a perspective view of a battery door of the system and method for a remote battery door button, in accordance with a disclosed embodiment.

FIG. 5B illustrates a perspective view of a remote body of the system and method for a remote battery door button, in accordance with a disclosed embodiment.

FIG. 6 illustrates a side perspective view of another embodiment of the system and method for a remote battery door button that has the button lock assembly in the remote body rather than the battery door.

FIG. 7 illustrates a close-up top perspective view of another embodiment of the system and method for a remote battery door button that has the button lock assembly in the remote body rather than the battery door.

### DETAILED DESCRIPTION

Persons of ordinary skill in the art will understand that the present disclosure is illustrative only and not in any way limiting. Other embodiments and various combinations of the presently disclosed system and method readily suggest themselves to such skilled persons having the assistance of this disclosure.

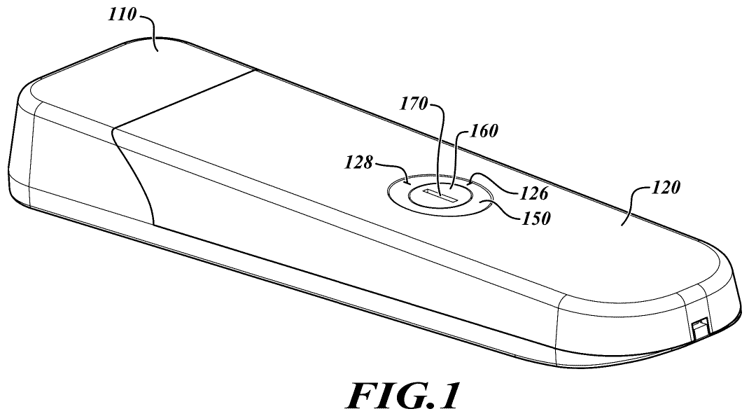

Each of the features and teachings disclosed herein can be utilized separately or in conjunction with other features and teachings to provide a system and method for a remote battery door button. Representative examples utilizing many of these additional features and teachings, both separately and in combination, are described in further detail with reference to attached FIGS. 1-7. This detailed description is intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method. Also, other methods and systems may be used.

Throughout the specification, claims, and drawings, the following terms take the meaning explicitly associated herein, unless the context clearly dictates otherwise. The term “herein”refers to the specification, claims, and drawings associated with the current application.

The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,”“an,”and “the”include singular and plural references.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

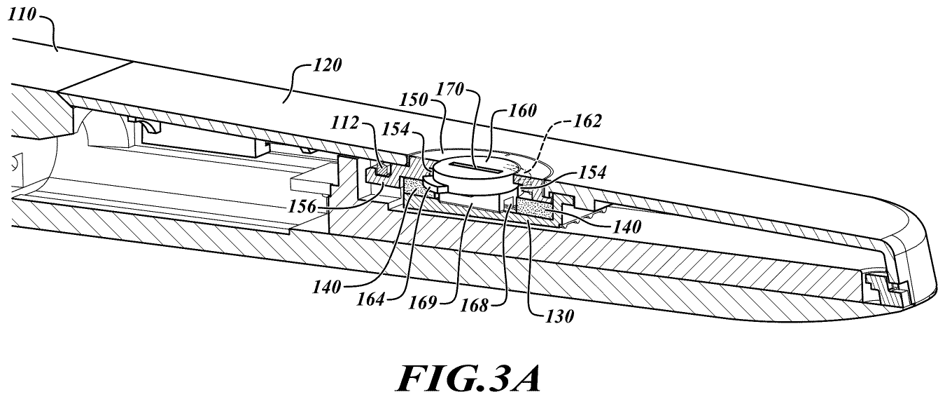

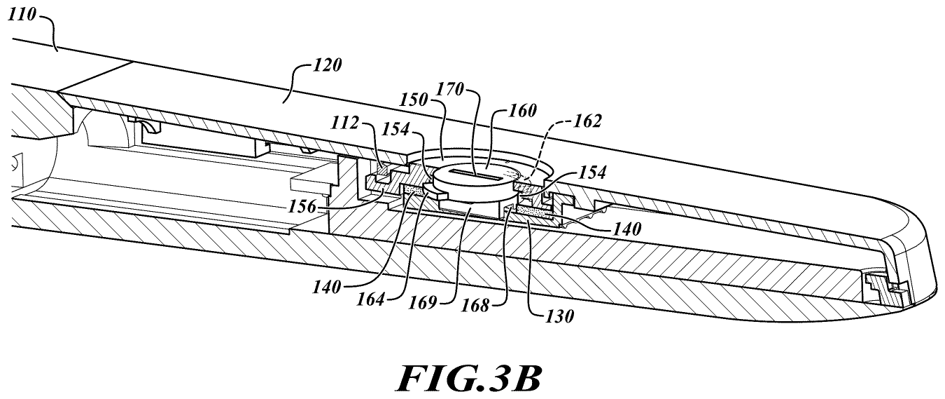

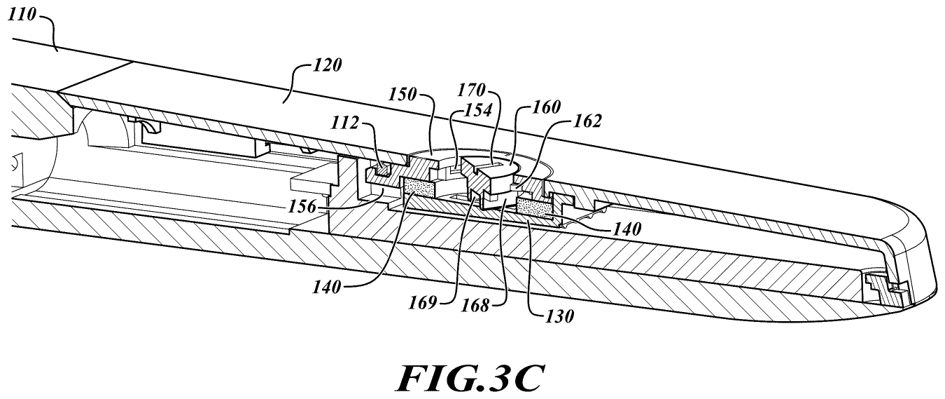

Referring now to FIGS. 1-3B, a system for a remote battery door button with two-phase activation (i.e., rotation of the inner lock button and depression of the inner and outer lock button) is shown. In one or more embodiments, the system includes: a remote body 110, a remote battery door 120, a holder bracket 130, a compression member 140, an outer lock button 150, an inner lock button 160, and a rotation slot 170. The remote body 110 includes a fixed latch 112 (as shown in FIGS. 3A and 3B) to which the remote battery door 120 and lock button assembly attach, as will be described in further detail below. As shown in FIG. 1, the remote battery door 120 has an unlocked position 128, where the rotation slot 170 is aligned longitudinally with the remote body 110, and a locked position 126, where the rotation slot 170 is aligned traverse to the remote body 110. In some embodiment, the system may be collectively referred to as a “remote control device.” In other embodiments, the system for a remote battery door button may be a remote door button for a compartment other than for a battery. In still other embodiments, the system for a remote battery door button may be a battery door button for a small, mobile electronic device that is not a remote control device.

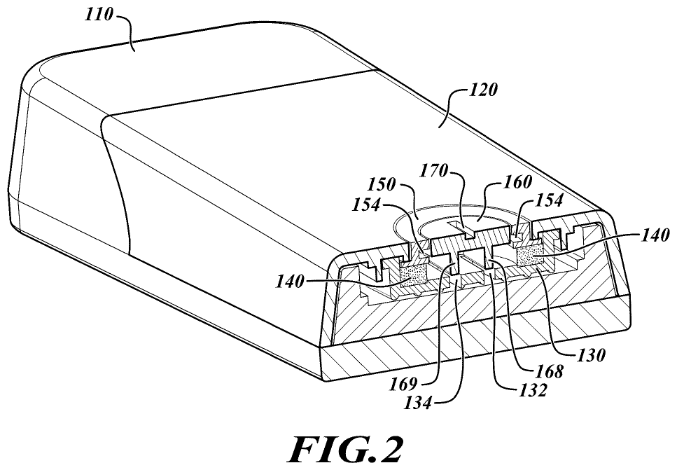

FIGS. 2, 3A, and 3B most clearly show the lock button assembly, which includes the holder bracket 130, a compression member 140, an outer lock button 150, and an inner lock button 160. Specifically, the holder bracket 130 is operatively connected to the remote battery door 120. Otherwise stated, while the holder bracket 130 is a separate component from the remote battery door 120 in most embodiments, the holder bracket 130 is secured to remote battery door 120 such that the holder bracket 130 does not move with respect to the remote battery door 120. In other embodiments, the holder bracket 130 may be formed as a single component with the remote battery door 120.

Thus, FIG. 3A shows the inner lock button 160 and the outer lock button 150 in an unlocked position 128. The outer lock button 150 also includes a hook latch 156 that selectively secures to the fixed latch 112 of the remote body 110, in a non-depressed position. As shown in FIG. 3A, the hook latch 156 of the outer lock button 150 is positioned to hook and secure to the fixed latch 112 of the remote body 110 when the buttons are in a non-depressed position.

However, as shown in FIG. 3B, when the inner lock button 160 and the outer lock button 150 are in an unlocked position 128, and are depressed (pushed inward into the remote body 110 by compressing the compression member 140), then the hook latch 156 detaches from the fixed latch 112 of the remote body 110, thereby enabling the remote battery door 120 to slidably disengage from the remote body 110.

Referring now to FIG. 3C where the lock button assembly is rotated into a locked position 126, the inner lock button 160 and the outer lock button 150 cannot be depressed when they are rotated into a locked position 126. Specifically, when the inner lock button 160 is in a locked position 126, then the one or more ribs 168, 169 on the inner lock button 160 cannot be depressed into the one or more slots 132, 134 of the holder bracket 130 due to their misalignment when in a locked position. Thus, the hook latch 156 cannot disengage from the fixed latch 112 of the remote body 110, and the remote battery door 120 cannot be slidably disengaged from the remote body 110, when the inner lock button 160 and the outer lock button 150 are in a locked position 126.

Notably, the holder bracket 130 includes one or more slots 132, 134. In the embodiment shown in FIG. 2, there are two slots 132, 134. In other embodiments, there are a smaller (e.g., one) or larger (e.g., three, four, etc.) number of slots in the holder bracket 130. Additionally, in still other embodiments there are differently shaped depressions or openings in the holder bracket 130 instead of slots. These different shaped openings could be circles, triangles, squares, or other polygon or non-polygonal shapes. What is significant is that the different shaped depressions or openings in the holder bracket 130 correspond to the position and orientation of the one or more ribs 168, 169 (or other protrusions) on the inner lock button 160, such that the one or more ribs 168, 169 on the inner lock button 160 may be depressed into the one or more slots 132, 134 of the holder bracket 130 when aligned in an unlocked position and the inner lock button 160 is depressed. Similarly, when the inner lock button 160 is rotated (e.g., 90 degrees, 80 degrees, 70 degrees, etc.) into a locked position, then the one or more ribs 168, 169 on the inner lock button 160 cannot be depressed into the one or more slots 132, 134 of the holder bracket 130 due to their misalignment when in a locked position and the inner lock button 160 is depressed.

The compression member 140 is mounted on the holder bracket 130. Specifically, the compression member 140 is sandwiched between the outer lock button 150 and the holder bracket 130, such that if the outer lock button 150 is depressed towards that holder bracket 130, the compression member 140 is initially compressed, but provides resistance that pushes the outer lock button 150 back into its original position after the depression force is removed. In the embodiment shown in FIGS. 2, 3A, and 3B, the compression member 140 is displayed as a compression pad. However, in other embodiments of the lock button assembly, the compression member 140 may be a spring, or biasing device.

Referring now to the outer lock button 150 of the lock button assembly shown in FIGS. 1-3B and 4B, the outer lock button 150 is operatively associated with the remote battery door 120. In this regard, the outer lock button 150 cannot rotate with respect to the remote battery door 120. However, the outer lock button 150 can be depressed in travel inward into the remote body 110 in an unlocked position 128 when the one or more ribs 168, 169 on the inner lock button 160 are aligned with the one or more slots 132, 134 of the holder bracket 130, and the inner lock button 160 is depressed.

Additionally, the lower surface of the outer lock button 150 rests upon the compression member 140. The outer lock button 150 is depressible by compressing the compression member 140 against the holder bracket 130 when the inner lock button 160 is in an unlocked position and is depressed, as described above. The outer lock button 150 is then pushed back into its original position after the depression force is removed by the resistance provided by the compression member 140.

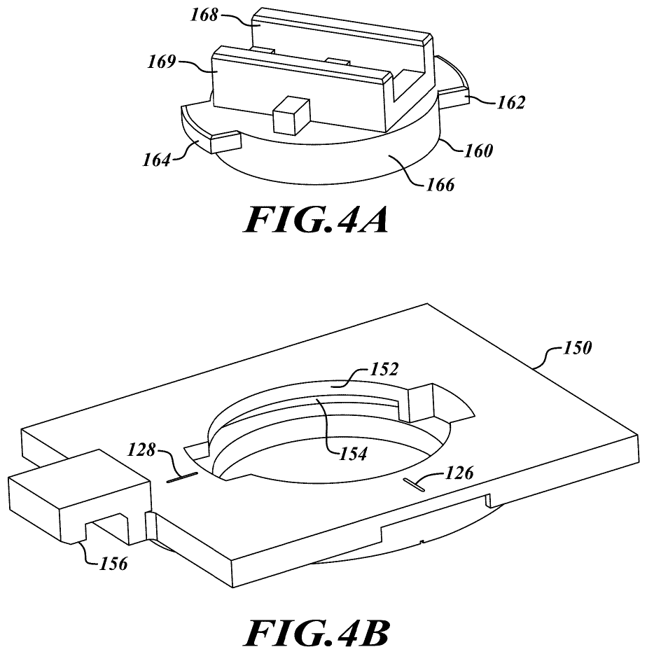

Furthermore, as most clearly shown in FIG. 4B, the outer lock button 150 includes an inner circumference wall 152 that has a groove 154 incorporated into the inner circumference wall 152. FIG. 4B is shown as a bottom perspective view so that the inner circumference wall 152, groove 154, and hook latch 156 are mostly clearly displayed. As will be described in further detail below, one or more tongues 162, 164 of the inner lock button 160 interact with the groove 154 in the inner circumference wall 152 to provide the ability for the inner lock button 160 to rotate with the outer lock button 150 using the groove 154. The interaction of the groove 154 in the outer lock button 150 with the one or more tongues 162, 164 of the inner lock button 160 also ensures that when the inner lock button 160 is depressed, the outer lock button 150 is also depressed, and moves in unison with the inner lock button 160 inwardly and outwardly (i.e., perpendicularly to the surface of the remote battery door 120), but not rotationally.

As shown in FIG. 3A, the outer lock button 150 also includes a hook latch 156 that selectively secures to the fixed latch 112 of the remote body 110 to secure the remote battery door 120 to the remote body 110. Accordingly, when the outer lock button 150 is in a non-depressed position, as shown in FIG. 3A, the hook latch 156 is positioned to hook and secure to the fixed latch 112 of the remote body 110. However, when the outer lock button 150 is in a depressed position (pushed inward into the remote body 110 by compressing the compression member 140), as shown in FIG. 3B, then the hook latch 156 detaches from the fixed latch 112 of the remote body 110, thereby enabling the remote battery door 120 to slidably disengage from the remote body 110.

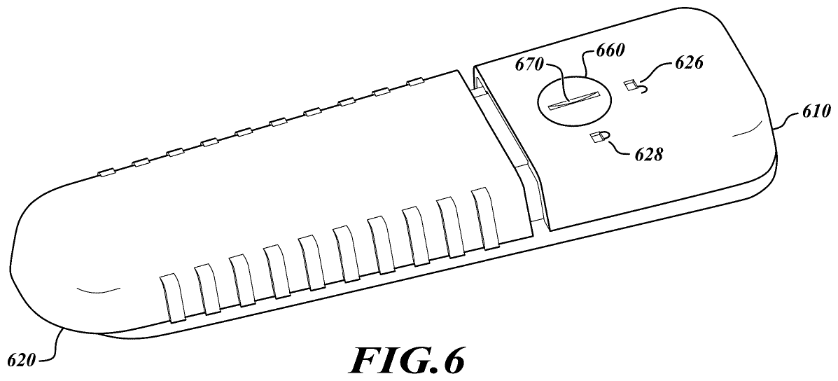

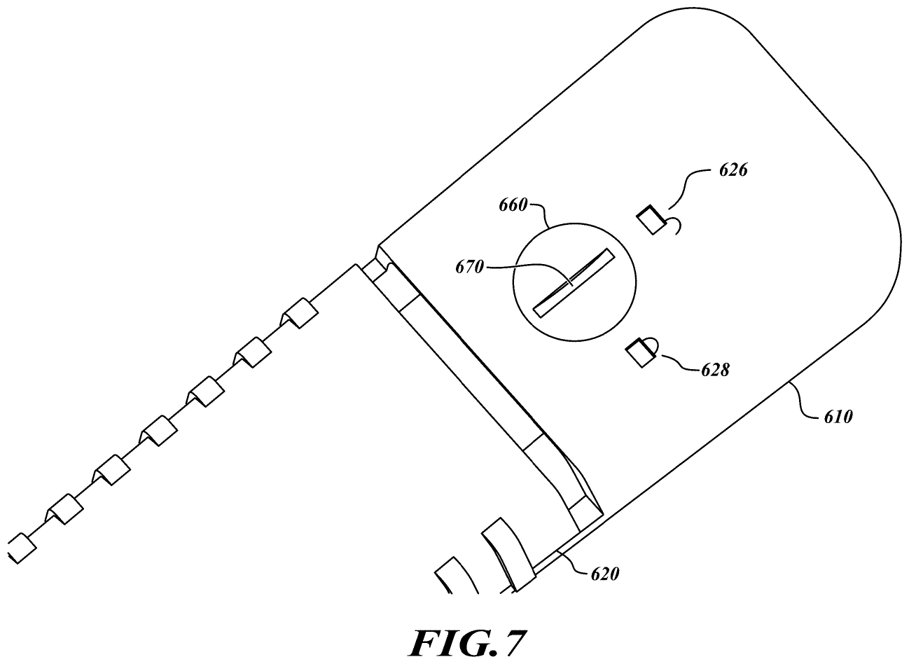

As will be described further below with respect to FIGS. 6 and 7, in other embodiments, the lock button assembly may be positioned on the remote body instead of the remote battery door. This alternate positioning may be for reasons such as the positioning of other components within the remote control device. In embodiments where the lock button assembly may be positioned on the remote body instead of the remote battery door, the fixed latch 112 may in turn be positioned on the remote battery door so that the hook latch 156 on the outer lock button 150 secures with the fixed latch 112 of the remote battery door.

Referring now to the inner lock button 160 of the lock button assembly shown in FIGS. 1-3B and 4A, the inner lock button 160 is seated within the outer lock button 150. In some embodiments, the inner lock button 160 includes one or more tongues 162, 164 on at least a portion of an outer circumference wall 166 of the inner lock button 160. In the embodiment shown in FIG. 4A, there are two tongues 162, 164. In other embodiments, there are a smaller (e.g., one) or larger (e.g., three, four, etc.) number of tongues positioned on the outer circumference wall 166 of the inner lock button 160. FIG. 4A is shown as a bottom perspective view so that the two tongues 162, 164 and ribs 168, 169 are mostly clearly displayed. Significantly, as shown most clearly in FIGS. 3A, 3B, 4A, and 4B, the one or more tongues 162, 164 of the inner lock button 160 interact with the groove 154 in the inner circumference wall 152 to provide the ability for the inner lock button 160 to rotate within the outer lock button 150 using the groove 154, while the outer lock button 150 remains rotationally fixed.

Additionally, as shown most clearly in FIGS. 2, 3A, and 3B, the lower surface of the inner lock button 160 includes one or more ribs 168, 169. As shown in FIG. 2, there are two ribs 168, 169 that align with the two slots 132, 134 of the holder bracket 130 when in the unlocked position 128. The one or more ribs 168, 169 are correspondingly shaped and sized to protrude into the one or more slots 132, 134 of the holder bracket 130 when the inner lock button 160 is depressed in the unlocked position 128, but not when the inner lock button 160 is depressed in the locked position 126.

Further, in other embodiments there are differently shaped protrusions or projections from the lower surface of the inner lock button 160 instead of ribs. These different shaped protrusions could be circles, triangles, squares, or other polygon or non-polygonal shapes. What is significant is that the different shaped protrusions or projections from the lower surface of the inner lock button 160 correspond to the position and orientation of the one or more slots 132, 134 (or other openings) in the holder bracket 130, such that the one or more ribs 168, 169 on the inner lock button 160 may be depressed into the one or more slots 132, 134 of the holder bracket 130 when aligned in an unlocked position 128 and the inner lock button 160 is depressed. Again, when the inner lock button 160 is rotated (e.g., 90 degrees, 80 degrees, 70 degrees, etc.) into a locked position 126, then the one or more ribs 168, 169 on the inner lock button 160 cannot be depressed into the one or more slots 132, 134 of the holder bracket 130 due to their misalignment when in a locked position and the inner lock button 160 is depressed.

When the inner lock button 160 is in the locked position 126, the inner lock button 160 is referred to as “out of phase.” Specifically, when the inner lock button 160 is “out of phase,” the ribs 168, 169 of the inner lock button 160 are rotated 90 degrees from the slots 132, 134 of the holder bracket 130. Accordingly, when the inner lock button 160 is “out of phase,” the ribs 168, 169 of the inner lock button 160 are misaligned from the slots 132, 134 of the holder bracket 130, and not depressable into the slots 132, 134 of the holder bracket 130. In other embodiments, when the inner lock button 160 is “out of phase,” the ribs 168, 169 of the inner lock button 160 are rotated less than 90 degrees (e.g., 70, 75, 80, or 85 degrees) or more than 90 degrees (e.g., 95, 100, 105, or 110 degrees) from the slots 132, 134 of the holder bracket 130.

Correspondingly, when the inner lock button 160 is in an unlocked position 128, the inner lock button 160 is referred to as “in phase.” Specifically, when the inner lock button 160 is “in phase,” the ribs 168, 169 of the inner lock button 160 are in alignment with the slots 132, 134 of the holder bracket 130. Accordingly, when the inner lock button 160 is “in phase,” the ribs 168, 169 of the inner lock button 160 are aligned with the slots 132, 134 of the holder bracket 130, and are depressable into the slots 132, 134 of the holder bracket 130.

The rotation of the inner lock button 160 from an unlocked position 128 (i.e., “in phase”) to a locked position 126 (“out of phase”) is achieved using the rotation slot 170. Specifically, the upper surface of the inner lock button 160 includes the rotation slot 170 for engaging with a tool to rotate the inner lock button 160 between a locked position 126 and an unlocked position 128. The “tool” may simply be a small coin, such as a dime, or a common flat head screwdriver. Thus, the inner lock button 160 may be locked and unlocked using a common “tool” such as a small coin, that most users are likely to have on their person or immediately nearby. It is the intention of this button lock assembly system not to require any specialty tools for opening the locking mechanism that may be difficult to locate when needed, thereby resulting in unacceptable user frustration. In this manner, the disclosed button lock assembly system overcomes the technological challenge of how to incorporate an appropriate locking mechanism for a remote battery compartment, while still making the locking mechanism not overly difficult to open. For example, having a locking mechanism for the battery compartment may be appropriate when small children are present, such as to prevent the small children from removing the battery door and batteries from the remote control device, which then could become a choking hazard. In this manner, the disclosed button lock assembly system strikes the delicate balance of being child-proof, but not adult-proof.

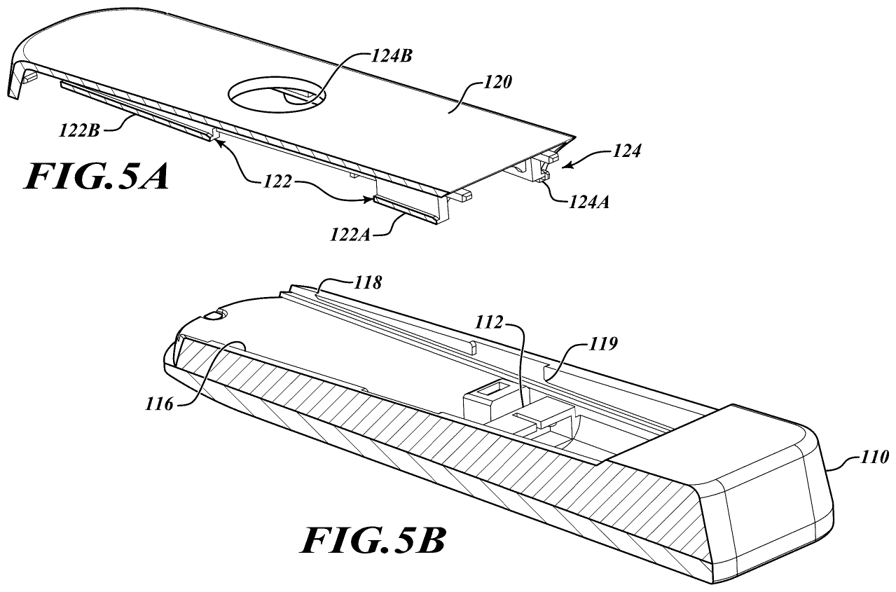

Referring now to FIGS. 5A and 5B, a remote battery door 120 and remote body 110 are shown. Specifically, FIG. 5A shows a remote battery door 120 that interacts with the button lock assembly, and FIG. 5B shows a remote body 110 that interacts with the button lock assembly. In the embodiment shown in FIG. 5A, the remote battery door 120 includes guiderails 122, 124 on each longitudinal side of the remote battery door 120. In particular, the guiderails 122, 124 on each longitudinal side of the remote battery door 120 include primary guiderails 122A, 124A and secondary guiderails 122B, 124B. In the embodiment shown in FIG. 5B, the remote body 110 includes a battery door opening and a longitudinal sidewall on each longitudinal side of the battery door opening. Each longitudinal sidewall includes guide tracks 116, 118 that are configured to receive the guiderails 122, 124 from the remote battery door 120. Additionally, in the embodiment shown in FIG. 5B, a detent component 119 is incorporated into the remote body 110 that interacts with a corresponding guiderail 124 on the remote battery door 120 to stop the remote battery door 120 at a designated travel stop position.

Referring now to FIGS. 6 and 7, an alternate embodiment of the system for a remote battery door button with two-phase activation is shown that has the button lock assembly in the remote body 610 rather than the remote battery door 620. This alternate positioning may be for a variety of reasons, such as the positioning of other components within the remote control device. In embodiments where the lock button assembly is positioned on the remote body 610 instead of the remote battery door 620, the fixed latch (not shown) may in turn be positioned on the remote battery door 620 so that the hook latch (not shown) on the outer lock button secures with the fixed latch of the remote battery door 620. As shown in FIGS. 6 and 7, the button lock assembly in the remote body 610 has a locked position 626 and an unlocked position 628, which are similar to the locked position 126 and the unlocked position 128 of the button lock assembly shown in FIG. 1. Additionally, in FIGS. 6 and 7 the upper surface of the inner lock button 660 includes a rotation slot 670, which is similar to the rotation slot 170 of the button lock assembly shown in FIG. 1.

The foregoing description, for purposes of explanation, uses specific nomenclature and formula to provide a thorough understanding of the disclosed embodiments. It should be apparent to those of skill in the art that the specific details are not required in order to practice the disclosure. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the disclosure to the precise forms disclosed, and those of skill in the art recognize that many modifications and variations are possible in view of the above teachings.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above described exemplary embodiments, but should be defined only in accordance with the following claims and their equivalents.

1. A system for a remote battery door button, the system comprising:
a remote body having a fixed latch;
a remote battery door having a locked position and an unlocked position, the remote battery door including guiderails on each longitudinal side of the door;
a holder bracket operatively connected to the remote battery door, the holder bracket including one or more slots;
a compression member mounted on the holder bracket;
an outer lock button operatively associated with the remote battery door, wherein a lower surface of the outer lock button rests upon the compression member, the outer lock button being depressible by compressing the compression member against the holder bracket, the outer lock button including an inner circumference wall having a groove therein, and wherein the outer lock button includes a hook latch that selectively secures to the fixed latch of the remote body to secure the remote battery door to the remote body when the outer lock button is not depressed; and
an inner lock button seated within the outer lock button, the inner lock button including one or more tongues on at least a portion of an outer circumference wall of the inner lock button, wherein the one or more tongues of the inner lock button are rotatable within the groove of the outer lock button so that the inner lock button is rotatable within the outer lock button between the locked position and the unlocked position, a lower surface of the inner lock button including one or more ribs that protrude into the one or more slots of the holder bracket when the inner lock button is depressed in the unlocked position but not when the inner lock button is depressed in the locked position,
wherein depressing the inner lock button when in the unlocked position also enables depression of outer lock button and unlatches the hook latch of the outer lock button from the fixed latch of the remote body.

2. The system of claim 1, wherein the remote battery door includes guiderails on each longitudinal side of the remote battery door.

3. The system of claim 2, wherein the guiderails on each longitudinal side of the remote battery door include primary guiderails and secondary guiderails on each longitudinal side of the remote battery door.

4. The system of claim 2, wherein the remote body includes a battery door opening and a longitudinal sidewall on each longitudinal side of the battery door opening, and wherein each longitudinal sidewall includes guide tracks that are configured to receive the guiderails from the remote battery door.

5. The system of claim 4, further comprising a detent feature on the remote body that interacts with a corresponding guiderail on the remote battery door to stop the remote battery door at a designated travel stop position.

6. The system of claim 1, wherein the compression member provides resistance force in response to the outer lock button being pushed, and wherein the compression member includes one or more of a compression pad, a spring, or biasing device.

7. The system of claim 1, wherein the inner lock button has a locked position where the inner lock button and outer lock button cannot be depressed, and an unlocked position where the inner lock button and outer lock button can be depressed into the remote body.

8. The system of claim 7, wherein when the inner lock button is in the locked position, the inner lock button is out of phase, with the ribs of the inner lock button rotated 90 degrees from the slots of the holder bracket.

9. The system of claim 7, wherein when the inner lock button is in an unlocked position, the inner lock button is in phase, with the ribs of the inner lock button in line with the slots of the holder bracket, and depressable into the slots of the holder bracket.

10. The system of claim 1, wherein an upper surface of the inner lock button includes a rotation slot for engaging with a tool to rotate the inner lock button between a locked position and an unlocked position.

11. A button lock assembly for a remote control device, the system comprising:
a holder bracket including one or more slots;
a compression member mounted on the holder bracket;
an outer lock button having a lower surface that rests upon the compression member, the outer lock button being depressible by compressing the compression member against the holder bracket, and wherein the outer lock button includes a hook latch that selectively secures to a fixed latch to secure a remote battery door to a remote body; and
an inner lock button seated within the outer lock button, wherein the inner lock button is rotatable within the outer lock button, a lower surface of the inner lock button including one or more protrusions that protrude into one or more openings of the holder bracket when the inner lock button is depressed in an unlocked position but not when the inner lock button is depressed in a locked position,
wherein depressing the inner lock button when in the unlocked position also enables depression of the outer lock button and unlatches the hook latch of the outer lock button from the fixed latch.

12. The device of claim 11, further comprising:
a remote body including the fixed latch; and
a remote battery door having a locked position and an unlocked position, the remote battery door including guiderails on each longitudinal side of the door.

13. The device of claim 11, further comprising:
a remote body having a locked position and an unlocked position, the remote battery door including guiderails on each longitudinal side of the door; and
a remote battery door including the fixed latch.

14. The device of claim 11, wherein the compression member provides resistance force in response to the button being pushed, and wherein the compression member includes one or more of a compression pad, a spring, or biasing device.

15. The device of claim 11, wherein the inner lock button has a locked position where the inner lock button and outer lock button cannot be depressed, and an unlocked position where the inner lock button and outer lock button can be depressed into the remote body.

16. The device of claim 15, wherein when the inner lock button is in the locked position, the inner lock button is out of phase, with the protrusions of the inner lock button rotated 90 degrees from the openings in the holder bracket.

17. The device of claim 15, wherein when the inner lock button is in an unlocked position, the inner lock button is in phase, with the protrusions of the inner lock button corresponding in position and orientation with the openings of the holder bracket, and depressable into the openings of the holder bracket.

18. The device of claim 11, wherein the outer lock button is not rotatable.

19. The device of claim 11, wherein an upper surface of the inner lock button includes a rotation slot for engaging with a tool to rotate the inner lock button between a locked position and an unlocked position.

20. A method for providing a locking assembly of a remote control device, the method comprising:
providing a remote body that includes a fixed latch and two longitudinal side walls, the two longitudinal side walls include guide tracks;
providing a remote battery door that is slidably engaged onto the remote body, the remote battery door including guiderails on each longitudinal side of the remote battery door, wherein the guiderails of the remote battery door correspondingly engages with the guide tracks of the remote body, wherein a holder bracket with a compression member mounted thereon is operatively connected to the remote battery door, the holder bracket including one or more slots;
securing a hook latch of an outer lock button to the fixed latch of the remote body to secure the remote battery door to the remote body, wherein the outer lock button is operatively associated with the remote battery door, the outer lock button including an inner circumference wall having a groove therein, and wherein a lower surface of the outer lock button rests upon the compression member;
rotating an inner lock button seated within the outer lock button from a locked position into an unlocked position, the inner lock button including one or more tongues on at least a portion of an outer circumference wall of the inner lock button, wherein the one or more tongues of the inner lock button are rotatable within the groove of the outer lock button;
depressing the inner lock button against the holder bracket via compression of the compression member with the inner lock button in the unlocked position, the inner lock button having a lower surface with one or more ribs that protrude into the one or more slots of the holder bracket when the inner lock button is depressed in the unlocked position; and
unlatching the hook latch of the outer lock button from the fixed latch of the remote body, in response to the depressing of the inner lock button and the outer lock button, thereby releasing the remote battery door from the remote body.
